(19) United States
(12) Patent Application Publication
(10) Pub. No.: US 2009/0066792 A1
(43) Pub. Date: Mar. 12, 2009

(54) Automotive, cargo, and homeland security camera system

(76) Inventor: Saad Issa, Arcadia, CA (US)

Correspondence Address: Cislo & Thomas LLP, 1333 2nd Street, Suite #500, Santa Monica, CA, 90401-4110, US

(21) Appl. No.: 11/899,889

(22) Filed: Sep. 7, 2007

(51) Int. Cl. H04N 7/18; H04N 5/225

(52) U.S. Cl. 348/148; 348/207.99; 386/117; 348/E07.085; 348/E05.001

(57) ABSTRACT

The automotive and/or vehicular camera system provides visual sensing devices for data generation and storage of visual information. On a vehicle or cargo container, cameras or other visual sensing devices may be placed strategically in order to provide a wide field of view. Data generated by the cameras may be transmitted by wire or otherwise to a central processing/memory/data capturing system. A power supply may supply power to both the processing and memory system as well as cameras. An interface may allow data and instruction transfer to and from the data capturing system. A variety of protocols can be used to achieve communication between the individual elements of the present invention and monitoring of other signals, events, and statuses may be achieved. By recording the history of the vehicle's operation and travels, forensic analysis is made easier should an accident or other event of interest occur.

### COPYRIGHT AUTHORIZATION

A portion of the disclosure of this patent document contains material which is subject to copyright and/or mask work protection. The copyright and/or mask work owner has no objection to the facsimile reproduction by anyone of the patent document or the patent disclosure, as it appears in the Patent and Trademark Office patent file or records, but otherwise reserves all copyright and/or mask work rights whatsoever.

### BACKGROUND OF THE INVENTION

1. Field of the Invention

This invention relates to monitoring systems and more particularly automobile/cargo monitoring system akin to a “black box” that records and transmits, via radio, satellite, or otherwise, visual and possibly audio signals, as well as information regarding the cargo contents and their locations ambient the vehicle/cargo container during travel or otherwise.

2. Description of the Related Art

Vehicle and live cargo monitoring and recording as well as transmission devices are generally useful in that they provide means by which forensic analysis can occur during travel, loadings, and after an accident, catastrophic event or otherwise. In performing such analysis, it is very helpful to have a record of the events that occurred immediately prior to the accident or other event of interest. Such recording systems are generally referred to as “black boxes” even though for airplanes the actually physical container is orange for easy visual detection. In aviation, such black boxes are used to monitor airplane/aircraft activity, pilot action, as well as providing voice recordings or cockpit events. Recently, in February 2006, a ferry sank in the Red Sea at a loss of hundreds of lives. A recording device was reported by news sources as being present and great interest arose as the events immediately prior to the sinking of the vessel are not known for certain (although a fire in the garage area may be responsible).

With the millions of cars or other cargo transportation vehicles traveling on highways and roads in the United States as well as with the millions of other cars and automobiles elsewhere in the world, it would be very useful to have a vehicular black box that would provide recording of events for similar forensic analysis, including, but not limited to, managing traffic and homeland security live inspections. However, there remains to be some improvement in such vehicular black boxes and they are not readily present in today's trucks, cars, automobiles, tractor trailers, other cargo transport, and the like.

Prior attempts have been made in the art with respect to vehicle monitoring and/or recording systems and otherwise. Brief descriptions of some of such prior attempts are set forth below. While the descriptions are believed to be accurate, no admission is made by them regarding their subject matter which is solely defined by the patent or reference involved.

| PATENT/PUBLICATION | | DATE OF |
|---|---|---|
| NUMBER | INVENTOR | ISSUE/PUBLICATION |
| 20050100329 | Lao et al. | May 12, 2005 |
| 6,795,111 | Mazzilli | Sep. 21, 2004 |
| 6,650,359 | Park | Nov. 18, 2003 |
| 20030193588 | Yuen et al. | Oct. 16, 2003 |
| JP 2001206253 | Yamagishi | Jul. 7, 2003 |
| 20030125991 | Logan | Jul. 3, 2003 |
| 6,570,609 | Heien | May 27, 2003 |
| 20030081127 | Kirmuss | May 1, 2003 |
| 6,141,611 | Mackey et al. | Oct. 31, 2000 |
| WO 96/16836 | Yaron | Jun. 6, 1996 |

U.S. Pat. No. 6,795,111 issued to Mazzilli is directed to a video camera system which has a 360° range for digital video recording inside and outside of an automotive vehicle.

U.S. Pat. No. 6,570,609 issued to Heien is directed to a method and apparatus for monitoring the operation of a motor vehicle for the purposes of determining causation and fault in the event of an accident, and to enhance physical security of the vehicle utilizes electronic digital cameras strategically placed to obtain sequential images of the area immediately adjacent the exterior, and optionally the interior, of the vehicle and to record those images in an electronic memory.

U.S. Pat. No. 6,141,611 issued to Mackey et al. is directed to one or more video cameras are mounted on the vehicle to make continuously a visual record of the scene in a region around the vehicle. In response to an accident detector trigger signal, the data stored on-board the vehicle is automatically transmitted over a wireless link (e.g., public access links such as CDPD, satellite and Iridium or a private link) to a central data base. Data in the central data base is connected by a digital data network such as the Internet or a secured intranet and the data can be accessed via a computer terminal of an authorized party, such as an insurance adjuster for the company providing coverage to the vehicle, a self-insured entity, or a loss management facility.

U.S. Pat. No. 6,650,359 issued to Park is directed to a system for acquiring and recording audio, visual and other information, relating to the condition or environment of a motor vehicle, and for storing the information at the vehicle for playback and analysis. Data is continuously and sequentially over-written until the system is deactivated. Playback may be accomplished through a computer or television set.

U.S. Patent Application Publication No. 20050100329 of Lao et al. is directed to a digital recording device that is optimized for field use in motor vehicles, and methods for capturing, storing, and retaining digital information recorded by such digital recording device, are disclosed. The digital recording device comprises a non-removable hard disk drive for data storage, eliminating the need to use removable media cartridges, and a small control panel, and is packaged in a ruggedized, compact form factor.

U.S. Patent Application Publication No. 20030081127 of Kirmuss is directed to a first camera providing a real-time video signal that corresponds to an observed outboard live-motion scene; and a digital video recorder receiving the video signal provided by the camera and recording the video signal in response to a trigger signal (e.g., an activation switch for a light bar or siren, an air bag sensor signal indicating air bag deployment, or depression of an emergency button or a dedicated recording activation switch).

U.S. Patent Application Publication No. 20030125991 of Logan is directed to a computerized locus investigation system for motor vehicles claims adjusters comprises an Internet-accessible database of photographs of street intersections and other potential motor vehicle accident sites (including intersections of any type of private or public ways accessible to motor vehicles), retrievable by queries specifying the intersecting streets or ways of interest.

U.S. Patent Application Publication No. 20030193588 of Yuen et al. is directed to a wirelessly remote control battery powered self-video capturing capability camera mounting device system especially for handheld video camera.

Japanese Patent No. JP2001206253 of Yamagishi is directed to an apparatus that will provide a traveling condition recording device for a vehicle capable of recording the condition around the vehicle just before happening of an accident effective to clear up the causes of the accident. Image pickup data by CCD cameras is synthesized by an image synthesizing unit, and recorded in a disk while using a DVD drive. A control unit indicates the stop of recording to the DVD drive when the predetermined time is passed after a collision sensor has detected a collision of the vehicle.

International Patent Publication No. WO 96/16836 of Yaron is directed to a system for detecting vehicles in a host vehicle's environment. The system preferably comprises at least one light emitting device attached to the host vehicle for illuminating the host vehicle's environment. The system further comprises at least one beam-forming device interfaced with a light-emitting device to illuminate the environment. Even more preferably, at least one photo-sensitive device attached to the host vehicle for receiving the reflected light from the vehicle in the host vehicle's environment is provided. The system utilized optical or infrared light thereby achieving a low cost and efficient vehicle-safety protection system.

### SUMMARY OF THE INVENTION

In view of the foregoing and other disadvantages inherent in the known types of vehicular monitoring systems now present in the prior art, the present invention provides a new vehicular and cargo monitoring system wherein the same can be used for recording events around an adjacent traveling automobile or the like.

The general purpose of the present invention, which will be described in greater detail, is to provide a new vehicle/cargo monitoring system, apparatus, and method which have many of the advantages of prior vehicle monitoring systems mentioned heretofore as well as many novel features that result in a new vehicular monitoring and activity recording system which is not anticipated, rendered obvious, suggested, or even implied by any of the prior art vehicular monitoring systems, either alone or in any combination thereof.

In one embodiment, four (4) or more cameras are mounted in a configuration so as to view all sides of an automobile or cargo container while it is in motion. Wires may lead from the cameras or may be wirelessly connect to a “black box” or other type of recorder which can store and/or transmit data and/or live pictures, a significant amount of video of data, possibly a month's worth or more, on a DVD or other memory device. Other memory devices may also be used.

In an alternative embodiment, instead of powering the recording cameras by the car's engine or battery, a solar panel or independent battery system may be used so that the cameras can be continuously running. Such power sources are generally in addition to the car and/or cargo container's regular power supply.

Other alternative embodiments may include possible voice recording, and the use of vehicle support systems such as that under the On Star™ trademark or the like might be achieved.

In the event of an automobile accident, or cargo box mishap, a proper authority, a police officer, or an insurance company can access the tamper-notifying black box or container to remove the media to determine the circumstances of the accident or mishap. Additional alternative embodiments may provide additional data transmission such that the data, real-time or otherwise, may be viewed on a website or other media platform.

In one embodiment of the present invention, an automotive camera system for a vehicle and/or cargo container has a processing system for processing signals and a memory media system coupled to the processing system. The memory media system records signals transmitted by the processing system. A sensing device is coupled to the processing system and transmits signals to the processing system for recording on the memory media system. In this way, events sensed by the sensing device are recorded for later review by the memory media system.

In another embodiment of the present invention, an automotive camera system for a vehicle or cargo container has a processing system for processing digital signals and a memory media system coupled to the processing system. The memory media system records signals transmitted by the processing system and stores the signals in memory media. The memory media may include removable and non-removable media where such removable media may be DVD, flash memory, hard disk drives, and tape drives, etc. while the non-removable media may be a non-removable memory coupled to a non-removable memory interface that enables storage and delivery of signals by the non-removable memory. A sensing device coupled to the processing system may transmit signals to the processing system for recording on the memory media system. The sensing device may be a camera, a camera positioned at an exterior corner of the vehicle; a camera has a horizontal field of view of approximately one-hundred eighty degrees (180°), a microphone, a transducer, an engine sensor, an operation sensors, a status sensors, among others. An external interface is coupled to and enables communication to and from both the processing system and the memory media system. An optional independent power source such as batteries or solar panels may supplement or independently power the automotive camera system. Events sensed by the sensing device are recorded for later review by the memory media system. Additionally, uses for this embodiment can extend to the use of satellite system(s) or otherwise to send information and pictures to central security or traffic operation of homeland security cargo offices.

### OBJECTS OF THE INVENTION

It is an object of the present invention to provide a vehicle and/or cargo container monitoring system.

It is another object of the present invention to provide a vehicle and/or cargo container monitoring system that allows recording of events around and adjacent to the vehicle or cargo container.

It is yet another object of the present invention to provide a vehicle/cargo container monitoring system or automotive camera system that may be retrofitted into an existing vehicle, automobile, and/or cargo container or one that may be installed during the manufacture.

It is yet another object of the present invention to provide an automotive camera system or vehicle/cargo container monitoring system that enables easy removal of the memory storage medium.

It is yet another object of the present invention to provide an automotive camera system that protects a removable data storage medium such that catastrophic impact of the surrounding vehicle preferably inflicts only minimal damage to the data storage medium.

These and other objects and advantages of the present invention will be apparent from a review of the following specification and accompanying drawings. The foregoing objects are some of but a few of the goals sought to be attained by the present invention and are set forth for the purposes of example only and not those of limitation.

### BRIEF DESCRIPTION OF THE DRAWINGS

FIG. 1 is a side elevational view of an automobile implementing the automotive camera system of the present invention showing an optional solar panel.

FIG. 2 is a top plan view of the automobile of FIG. 1 in partial cut away mode to show some of the interior of the vehicle and show areas that may be covered or have video signal captured by the cameras of the automotive camera system of the present invention.

FIG. 3 is a side elevational view of the automobile with the automotive camera system of FIG. 1 and partial cut away mode showing the interior of the vehicle, the video memory system in one embodiment, and the optional independent battery system.

FIG. 4 is a schematic drawing showing certain elements of the automotive camera system of the present invention in relationship to the cameras in an automobile associated with the automotive camera system.

FIG. 5 is an overhead view of an area in which vehicles/containers implementing the present system might operate.

FIG. 6 is a rear view of a container ship laden with containers that may implement the present system.

### DESCRIPTION OF THE PREFERRED EMBODIMENT(S)

The detailed description set forth below in connection with the appended drawings is intended as a description of presently-preferred embodiments of the invention and is not intended to represent the only forms in which the present invention may be constructed and/or utilized. The description sets forth the functions and the sequence of steps for constructing and operating the invention in connection with the illustrated embodiments. However, it is to be understood that the same or equivalent functions and sequences may be accomplished by different embodiments that are also intended to be encompassed within the spirit and scope of the invention.

The present invention resides in an automotive camera system that enables recording of events taking place in and around the area adjacent to the automobile and or cargo container. Such cameras may be located in the four corners of the vehicle or cargo container or otherwise. A variety of alternative embodiments of the present invention enable a variety of configurations to be achieved according to the particular application, vehicle, or circumstances involved. A removable data storage media system may be used in conjunction with the automotive camera system set forth herein. Alternatively, downloadable memory or otherwise could also provide means by which signals received for data storage are recorded and preserved. Preferably, in a robust environment, the automotive camera system set forth herein preserves the data storage media (in whatever form it takes) such that a catastrophic incident generally does not destroy or alter signals that have been recorded in or on the data storage media.

Referring to the drawings, where like numerals of reference designate like elements throughout, it will be noted that the automotive camera system set forth herein is generally related to a basic vehicle 100. The vehicle 100 may take a variety of different forms and may generally be any of a number of vehicles traveling over land. This includes trucks, cars, SUVs, tractor trailer rigs, or cargo containers, and any of the variety of vehicles that travel over roads and highways. In some embodiments, motorcycles may also manifest the automotive camera system set forth herein.

For convenience, all such vehicles are referred to in general as “automobiles,” or “vehicles,” or the like and such mention of such vehicles is meant to incorporate all such vehicles. Further, as used here in, the term “vehicle” or the like (“automobile,” “car,” “container,” etc.) refers to any transportation device of appropriate nature for moving people and/or cargo.

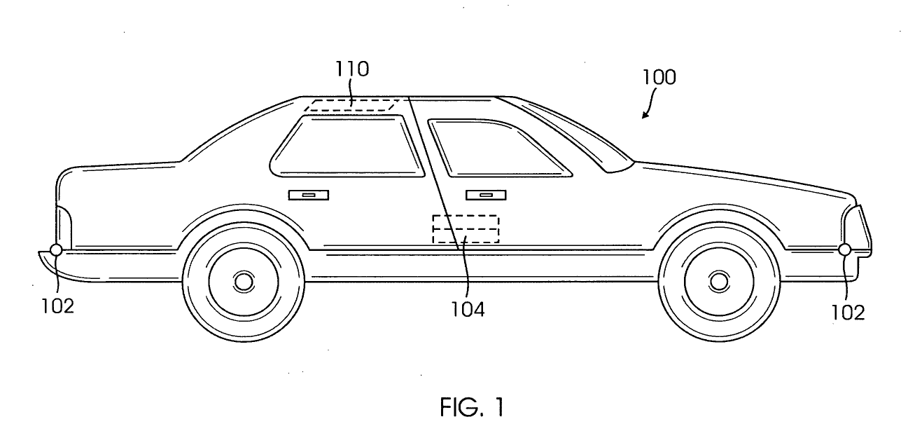

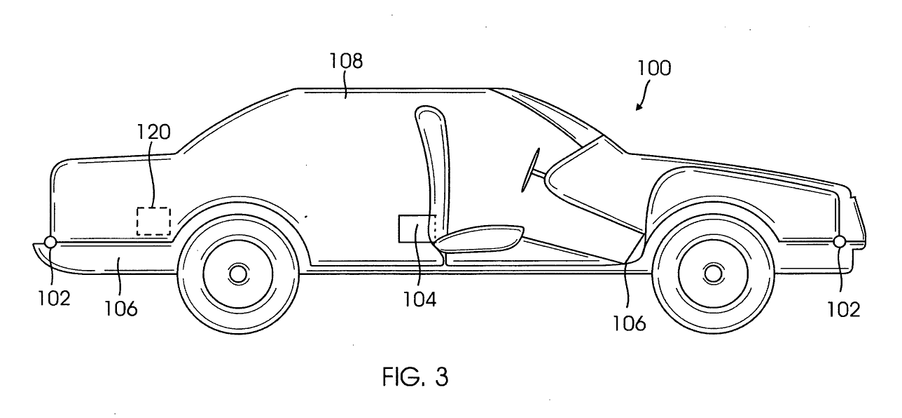

As shown in FIGS. 1 and 3, the vehicle 100 may manifest its cameras 102 at the corners of the vehicle 100. The cameras 102 are in communication with a data capturing system 104 that enables the capture of the data generated by the sensing units, such as the cameras 102, that are present in automotive camera system set forth herein. Such data may include video signals, audio signals, vehicle status or operational signals, or otherwise. Communication between the cameras or other sensing devices 102 and the data capturing system 104 may take place via wires 106, via wireless communication, or via other communications now known or developed in the future. For example, fiber optics might be used to communicate the video signals from the cameras 102 to the data capture system 104. All such data communication systems referred to generally herein as “wires” for the purposes of convenience only and not of limitation.

As can be seen in FIGS. 1 and 3, the cameras 102 are generally small in nature and may be those that have recently been developed with respect to small camera devices used for surveillance, monitoring and otherwise. Internet-related cameras may also be put to good use if appropriate and such cameras may be hardened against inclement weather, infiltration of water and the like, and protection from dust, dirt, etc. Such cameras may be applied to the exterior of the vehicle 100. Alternatively, they can be manufactured as part of the vehicle 100 so that they are less obtrusive, less subject to vandalism, and may be more aesthetically appealing.

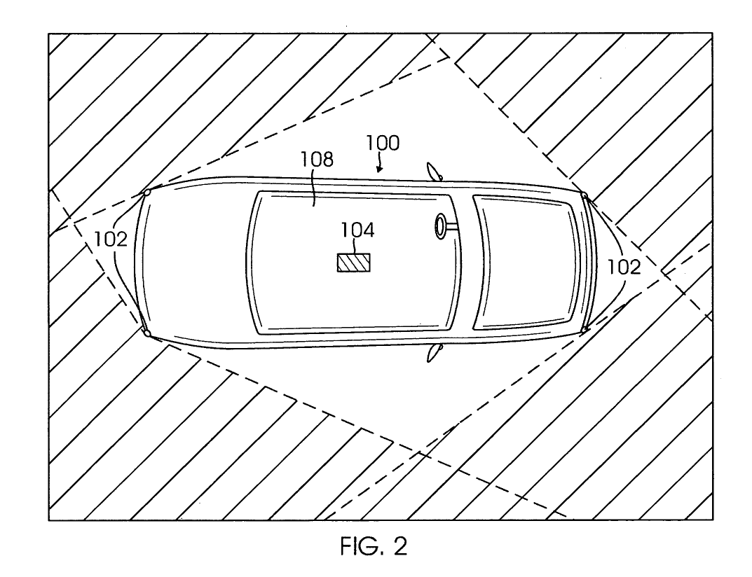

In whatever shape and whatever construction the cameras take, they are generally situated at points about the perimeter of car so that they give a good view of the surrounding area. FIG. 2 shows one embodiment of the placement pattern that situates the cameras 102 generally at the four corners of the vehicle 100. Depending upon the vision scope of the cameras, such a pattern as set forth in FIG. 2 may be realized. However, fisheye lenses, the addition of supplementary cameras, or the availability of other visual sensing devices may alter and possibly greatly increase the scope covered area able to be subject to visual data capture.

In alternative embodiments, sound, particularly human voices, within the passenger section 108 of the vehicle 100 may provide additional information that is useful in the case of an accident. Further alternative embodiments may place additional cameras showing the activities inside the passenger compartment 108. Furthermore, detection system may use additional wires 106 or otherwise in order to provide directional information, possibly along the lines of GPS, as well as speed, temperature, motor condition and operation (such as RPM) oil temperature, oil pressure, brake pressure, and the like. A further embodiment may operate in conjunction or in tandem with vehicle support systems such as that marketed under the On Star™ trademark or the like. Furthermore, the data gathered by the cameras 102 or other sensing devices may be transmitted by cell phone, satellite linkup or otherwise to a central or distributed information retrieval service. Along these lines, a website may provide instantaneous or real-time access to the activities and data supplied by the automotive camera system. Such data could then be recorded off-site and readily retrievable should a catastrophic event or accident occur.

In all, the automotive camera system may become a vehicle monitoring system that is able to provide after-the-fact information with regards to events and circumstances immediately prior a crash, accident, or other event.

FIG. 1 shows an optional solar panel 110 while FIG. 3 shows an optional independent battery system 120. Both of the alternative power supplies may supplement or complement the power supply already available for the car's battery (not shown) in the car's engine (not shown).

In the event of an automobile accident, the data stored in the data capture system 104 could be retrieved for forensic analysis. Under some circumstances, the data capture system may be tamper proof or indicative if tampering has occurred. It may be preferable to have authorized individuals of an organization, or other officials, be the only ones to be able to properly access the data capture system 104. In this way, the integrity of the evidence and data present in the data capture system 104 may be preserved for use in formal decision making circumstances such as a courtroom trial or the like. Furthermore, insurance companies may require that such data as captured by the data capturing system 104 suffer no loss of integrity and be reliable such that any compensation due from an insurer is legitimately paid.

The data capturing system 104 may rely upon any data storage protocols for devices now known or later developed. These include DVD, flash memory, hard disk drives, tape drives, etc. As mentioned above, it may be important to ensure that the data capturing system 104 video memory system, or the like can withstand impact of the surrounding vehicle 100, much in a manner that as known in aviation black boxes. As a result, the data capturing system 104 may be placed in a reinforced container such as a steel box reinforced by angle bars at the seams or otherwise. Additionally, the data capturing system may be located in a position within the vehicle that is generally safe from exterior impact.

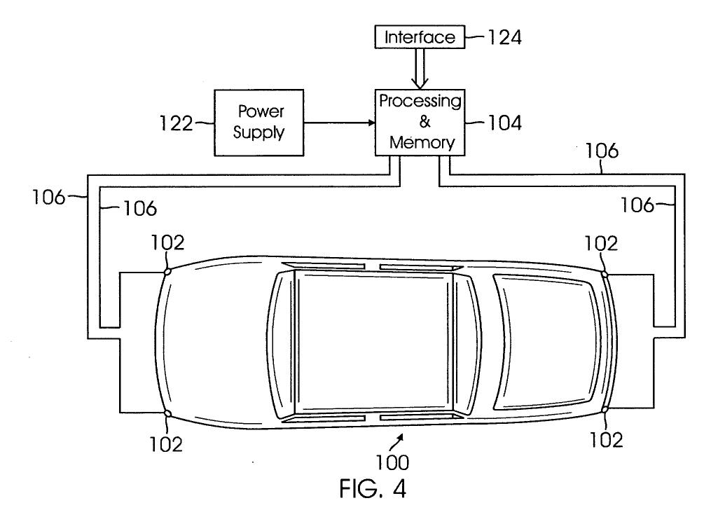

Schematically, FIG. 4 shows one embodiment that might be constructively used to achieve the automotive camera system of the present invention. Vehicle 100 has cameras 102 at its corners which are connected by wires 106 to a processing and memory system which may also serve as a data capturing system 104. A power supply 122 supplies power to the processing/memory/data capturing system 104 which may also, via the wires 106, supply power to the cameras 102. As indicated above, the data capturing system 104 may rely upon many data storage systems now known or later developed with preferences being for data systems that are high capacity and generally renewable such as DVD, flash memory, or the like. An interface 124 may enable interaction and communication with the processing and memory system 104. The interface may be any interface system now known or later developed including USB, firewire, wireless protocol, TCP/IP, etc.

Particularly with internal memory present in the processing and memory system 104, the interface 124 may provide means by which information stored in the memory can be downloaded. Such downloading can take place physically as through a wire (USB/firewire) or wirelessly as by a cell phone connection or otherwise.

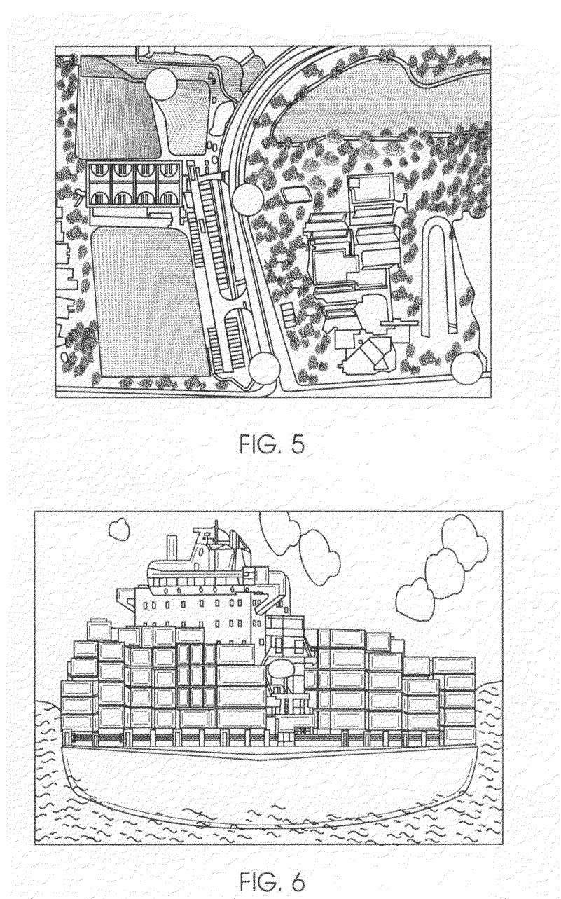

In FIG. 5 a vehicle incorporating the present system can be in communication with a wide or global network. A transportation center or other information clearinghouse can advise the vehicle of road status and other information with live pictures or the like. To manage efficiency in transportation and to reduce energy consumption. The white dots may represent vehicles in the present system.

In FIG. 6, a number of cargo containers are shown. Each cargo container may incorporate the present system by including recording devices such as cameras, microphones, and “black box” type signal storage systems. Activity regarding the loading and contents of each container can be recorded and transmitted so as to provide inspection and a record of activity history for Homeland Security or otherwise. Bar code or other scanning records can be included with the other signal recording and/or transmissions.

While the present invention has been described with regards to particular embodiments, it is recognized that additional variations of the present invention may be devised without departing from the inventive concept.

What is claimed is:

1. An automotive camera system as substantially disclosed herein.

2. An automotive camera system for a vehicle and/or cargo container, comprising:
a processing system for processing signals;
a memory media system coupled to said processing system, said memory media system recording signals transmitted by said processing system; and
a sensing device coupled to said processing system, said sensing device transmitting signals to said processing system for recording on said memory media system; whereby
events sensed by said sensing device are recorded for later review by said memory media system.

3. An automotive camera system for a vehicle or cargo container as set forth in claim 2, wherein said processing system further comprises:
a processing system adapted to process digital signals.

4. An automotive camera system for a vehicle or cargo container as set forth in claim 2, wherein said memory media system further comprises:
a memory media system adapted to receive a removable media.

5. An automotive camera system for a vehicle or cargo container as set forth in claim 4, wherein said memory media system further comprises:
said removable media selected from the group consisting of DVD, flash memory, hard disk drives, and tape drives.

6. An automotive camera system for a vehicle or cargo container as set forth in claim 2, wherein said memory media system further comprises:
a non-removable memory; and
a non-removable memory interface enabling storage and delivery of signals by said non-removable memory.

7. An automotive camera system for a vehicle or cargo container as set forth in claim 2, wherein said sensing device further comprises:
a sensing device selected from the group consisting of cameras, microphones, transducers, engine sensors, operation sensors, and status sensors.

8. An automotive camera system for a vehicle or cargo container as set forth in claim 2, wherein said sensing device further comprises:
a camera positioned at an exterior corner of the vehicle.

9. An automotive camera system for a vehicle or cargo container as set forth in claim 8, wherein said camera further comprises:
a camera having a horizontal field of view of approximately one-hundred eighty degrees (180°).

10. An automotive camera system for a vehicle or cargo container as set forth in claim 2, further comprising:
an external interface coupled to an enabling communication to and from both said processing system and said memory media system.

11. An automotive camera system for a vehicle or cargo container as set forth in claim 2, further comprising:
an independent power source coupled to one or more of said processing system, said memory media system, and said sensing device.

12. An automotive camera system for a vehicle or cargo container as set forth in claim 2, wherein said independent power source further comprises:
an independent power source selected from the group consisting of batteries and solar panels.

13. An automotive camera system for a vehicle or cargo container, comprising:
a processing system for processing digital signals;
a memory media system coupled to said processing system, said memory media system recording signals transmitted by said processing system and storing said signals in memory media;
said memory media selected from the group consisting of removable and non-removable media;
said removable media selected from the group consisting of DVD, flash memory, hard disk drives, and tape drives;
said non-removable media including a non-removable memory, said non-removable media coupled to a non-removable memory interface enabling storage and delivery of signals by said non-removable memory;
a sensing device coupled to said processing system, said sensing device transmitting signals to said processing system for recording on said memory media system;
said sensing device selected from the group consisting of cameras, a camera positioned at an exterior corner of the vehicle; a camera having a horizontal field of view of approximately one-hundred eighty degrees (180°), microphones, transducers, engine sensors, operation sensors, and status sensors; and
an external interface coupled to and enabling communication to and from both said processing system and said memory media system; whereby
events sensed by said sensing device are recorded for later review by said memory media system.

14. An automotive camera system for a vehicle as set forth in claim 13, further comprising:
an independent power source coupled to one or more of said processing system, said memory media system, and said sensing device, said independent power source selected from the group consisting of batteries and solar panels.
